(19) United States
(12) Patent Application Publication
(10) Pub. No.: US 2020/0231275 A1
(43) Pub. Date: Jul. 23, 2020

(54) DUAL ROTOR SYSTEM

(71) Applicant: Boaz Barry Groman, Boca Raton, FL (US)

(72) Inventor: Boaz Barry Groman, Boca Raton, FL (US)

(21) Appl. No.: 16/741,770

(22) Filed: Jan. 14, 2020

Related U.S. Application Data
(60) Provisional application No. 62/793,911, filed on Jan. 18, 2019.

(51) Int. Cl. B64C 27/10; F04D 25/06; B64D 27/24; F04D 29/26

(52) U.S. Cl. CPC B64C 27/10; F04D 29/26; B64D 27/24; F04D 25/06

(57) ABSTRACT

A contra-rotating dual rotor system may be driven by an electric motor disposed outside of the rotor system. A first rotor may be driven by a drive shaft protruding out from the front (or top) of the motor. A second rotor, mounted to the front of the motor, may be driven by the motor housing itself, via an extension of the motor housing which is coaxial with the drive shaft.

### CROSS-REFERENCE TO RELATED APPLICATION(S)

Filing date benefit (priority) is claimed from U.S. 62/793,911 filed 18 Jan. 2019, incorporated by reference herein.

### TECHNICAL FIELD

The invention relates, generally, to a dual rotor motor having counter (or contra) rotating output shafts, such as may be utilized for aircraft (particularly helicopters) having counter-rotating propellers, and for wind turbines having counter-rotating blades. The invention may also be used for propelling boats, torpedoes and the like, in and through water.

### BACKGROUND

One main design consideration for aircraft is the force applied on the chassis due to the rotation of the propellers. One type of helicopter design utilizes co-axial rotors (see https://en.wikipedia.org/wiki/Coaxial_rotors) to neutralize the forces acting on the helicopter chassis by the rotating blades; accomplished by having two contra-rotating blades along the same axis. Some aircraft utilize this concept for forward propulsion. The counter (or contra) rotating propellers/blades may reduce net torque, thereby relaxing demand on a tail rotor (or anti-torque air vents) of a helicopter.

This type of design provides substantial benefits such as superior control, reduced structural strength requirements, elimination of the stabilizing rotor, and enhanced safety for all the above reasons. Additionally, more blade area generates more lift at lower blade speed therefore reducing stresses. It also allows for shorter blades than the traditional single rotation rotor designs so the rotors fit into tighter landing spaces. It also requires less blade movements to correct for dissymmetry of lift due to forward speed. Plus reduction of rotor tip speeds which become less efficient as they approach the speed of sound.

These same benefits apply to co-axial propeller—both push and pull—propulsion technology and are applicable to the reverse usage where wind is propelling the co-axial rotors to drive a generator for electric power generation, or to drive push propellers for torpedoes where minimizing rotation and turning is crucial for precision guidance.

However, to date, co-axial rotor design requires complex gearbox mechanisms to implement. Such complexity increases the aircraft weight and cost (initial and maintenance) while reducing reliability and efficiency. That's why most common helicopter designs gravitate to the traditional design with a stabilizing (tail) rotor to counteract the lift rotors' rotational torque. The following video (https://youtu.be/uAQpslSWKf4) shows an extreme design that utilizes the counter rotating rotors while avoiding the co-axial design.

Most recently, ‘drone’ type devices utilize a plurality of electric motors which all operate in coordination to achieve stability and propulsion. These devices are dependent on computers and sensors to measure and control these plurality of motors in order to stay in the air. Most of these designs mount two motors axially with each propelling a blade rotating in opposite directions. Because the axis of these two motors are only collinear and not truly co-axial there are residual twisting torques that are applied on the aircraft. These residual torques are neutralized by a plurality of motor configurations and complex controls of motor speeds, etc.

### Some Publications (References)

JP 2012011990 (JP 990) discloses 2 contra-rotating propeller motor. 2 or more propellers or rotors, or the like, are rotated in opposite directions by 1 or more motors, and an anti-torque is completely canceled and a shaft coaxial with the axis of rotation of the motor is supported by bearings. In addition, power supply is performed by an electrode mounted on the coaxial rod and a power supply brush attached to the bearing. Comments distinguishing applicant's invention from this reference (JP 990) are presented below.

U.S. Pat. No. 8,464,511 discloses a turbomachine comprises a turbine shaft, first and second rotors, first and second propulsion stages, and a magnetic stator. The first rotor is rotationally coupled to the turbine shaft, and coaxially arranged along an axis. The first propulsion stage is rotationally coupled to the first rotor, opposite the turbine shaft. The second rotor is coaxially arranged about the first rotor, and the second propulsion stage is rotationally coupled to second rotor, opposite the turbine shaft and adjacent the first propulsion stage. The magnetic stator is coaxially arranged between the first rotor and the second rotor, forming a magnetic coupling between the and second rotors to drive the second propulsion stage in contra-rotation with respect to the first propulsion stage.

US 2013/0181562 discloses a dual rotor machine having a stator includes at least one excitation element, a first rotor located between the at least one excitation element and an axis, the first rotor configured to rotate about the axis, and a second rotor on the other side of the at least one excitation element from the axis, the second rotor configured to rotate about the axis.

### SUMMARY

It is an object of the invention disclosed herein, in its various embodiments, to provide improvements in dual-rotor systems, more particularly to systems having contra-rotating propellers.

Disclosed herein is a simple ‘method’ and ‘mechanism’ that facilities the co-axial rotor design, and which may circumvent some of the limitations described above. Specifically, this innovation enables a single (electric) motor to generate co-axial rotor motion without the need for a gearbox mechanism or complex controls for balancing the rotors, while providing a substantially constant and instantaneous balance of torque and rotor speed to both shafts. And, generally, the techniques disclosed herein may be implemented largely utilizing existing motor technologies to realize.

According to the invention, generally, a contra-rotating dual rotor system may be driven by an electric motor disposed outside of the rotor system. A first rotor may be driven by a drive shaft protruding out from the front (or top) of the motor. A second rotor, mounted to the front of the motor, may be driven by the motor housing itself, via an extension of the motor housing which is coaxial with the drive shaft.

According to some embodiments or examples of the invention, a dual rotor system may comprise: a motor comprising a housing and a first output shaft extending from a front (top) end of the motor; and an extension of the housing extending from the front end of the motor, said extension being coaxial with the output shaft and functioning as a second output shaft. The two rotors and propellers are disposed on the same end of the motor. A first propeller (rotor) may be driven by the first output shaft, in a first direction; and a second propeller (rotor) may be driven by the second output shaft, in a second direction opposite to the first direction. When the motor is powered, the rotors may rotate in opposite directions.

The motor may be an electric motor. Slip rings (conductive tracks) may be disposed on an exterior of the motor housing. Brushes cooperate with (contact) the slip rings, and receive electrical power from an external source to power the electric motor.

At least one bearing may be disposed about the motor housing to support the motor with respect to a “fixed” external structure (such as airframe or pylon). A universal joint may be disposed between the motor and the rotors to allow the rotors to tilt. The first and second output shafts may be relatively long, and the universal joint may be disposed relatively close to the rotors.

The dual rotor system may be incorporated into flying machines, boats, fans, turbines, etc.

Mass may be added to one or both of the rotors (or propellers) so their moments of inertial are equal. Braking forces may be selectively applied to the rotors. Bearings of equal size and/or of equal quantity may be mounted to support both the inner and outer rotors to the frame (fixed external structure).

According to some embodiments or examples of the invention, a method of driving contra-rotating propellers may comprise: providing an electric motor comprising a housing and a first output shaft extending from a front (top) end of the motor; and an extension of the housing extending from the front end of the motor, said extension being coaxial with the output shaft and functioning as a second output shaft; disposing propellers on the first and second output shafts; and powering the motor.

Other objects, features and advantages of the invention(s) disclosed herein, and their various embodiments, may become apparent in light of the descriptions of some exemplary embodiments presented herein.

### BRIEF DESCRIPTION OF THE DRAWINGS

Reference will be made in detail to embodiments of the disclosure, non-limiting examples of which may be illustrated in the accompanying drawing figures (FIGs). The figures may generally be in the form of diagrams. Some elements in the figures may be exaggerated, others may be omitted, for illustrative clarity. Some figures may be in the form of diagrams.

Although the invention may be described in the context of various exemplary embodiments, it should be understood that it is not intended to limit the invention to these particular embodiments, and individual features of various embodiments may be combined with one another. Any text (legends, notes, reference numerals and the like) appearing on the drawings are incorporated by reference herein.

FIG. 1 is a diagram, in cross-sectional view, of a dual rotor motor system, according to an exemplary embodiment of the invention.

FIG. 2 is a diagram, in cross-sectional view, of the contra-rotating propeller arrangement of JP 2012011990.

### DETAILED DESCRIPTION

Various embodiments (or examples) may be described to illustrate teachings of the invention(s), and should be construed as illustrative rather than limiting. It should be understood that it is not intended to limit the invention(s) to these particular embodiments. It should be understood that some individual features of various embodiments may be combined in different ways than shown, with one another. Reference herein to “one embodiment”, “an embodiment”, or similar formulations, may mean that a particular feature, structure, operation, or characteristic described in connection with the embodiment is included in at least one embodiment of the present invention. Some embodiments may not be explicitly designated as such (“an embodiment”).

The embodiments and aspects thereof may be described and illustrated in conjunction with systems, devices and methods which are meant to be exemplary and illustrative, not limiting in scope. Specific configurations and details may be set forth in order to provide an understanding of the invention(s). However, it should be apparent to one skilled in the art that the invention(s) may be practiced without some of the specific details being presented herein. Furthermore, some well-known steps or components may be described only generally, or even omitted, for the sake of illustrative clarity. Elements referred to in the singular (e.g., “a widget”) may be interpreted to include the possibility of plural instances of the element (e.g., “at least one widget”), unless explicitly otherwise stated (e.g., “one and only one widget”).

In the following descriptions, some specific details may be set forth in order to provide an understanding of the invention(s) disclosed herein. It should be apparent to those skilled in the art that these invention(s) may be practiced without these specific details. Any dimensions and materials or processes set forth herein should be considered to be approximate and exemplary, unless otherwise indicated. Headings (typically underlined) may be provided as an aid to the reader, and should not be construed as limiting.

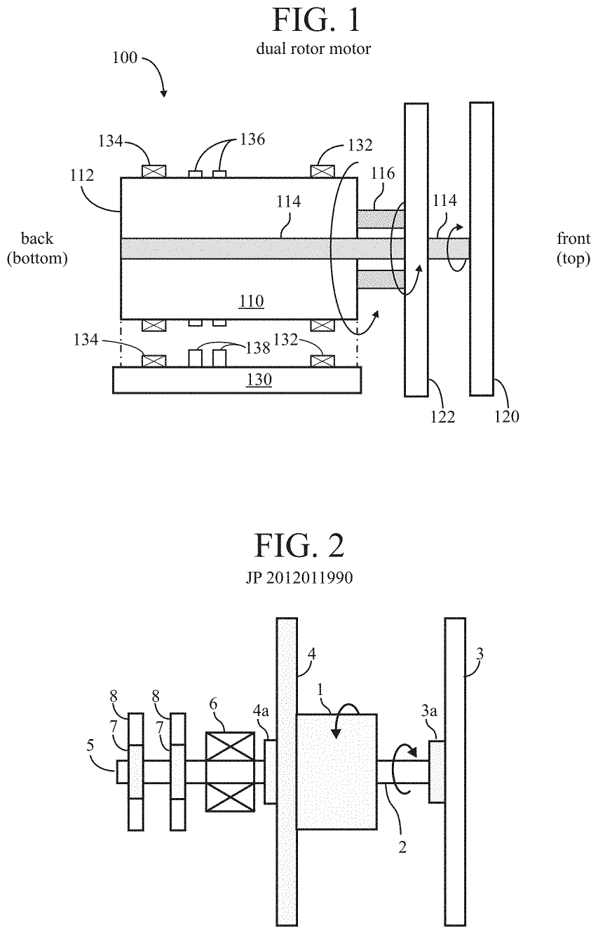

FIG. 1 is a cross-sectional view of a dual rotor motor system 100, according to an exemplary embodiment of the invention. The system 100 generally comprises an electric motor 110 with a housing 112. The system further comprises two rotors (or propellers) 120 and 122.

A drive shaft 114 is shown exiting the front (or top) end of the motor 110. The rotor 120 is connected in any suitable manner (such as with a hub, not shown) to the drive shaft 114.

An extension 116 of the motor housing is shown projecting from the front (or top) end of the motor 110. The rotor 122 is connected in any suitable manner (such as with a hub, not shown) to the extension.

The drive shaft 114 may pass through a hub for the rotor 122.

The extension 116 may be coaxial with the drive shaft 114. The extension 116 may extend a distance (D1) from the front of the motor. The drive shaft 112 may extend a distance (D2) from the front of the motor. The distance D2 may be greater than the distance D1, which would put the rotor 120 ahead of (or atop) the rotor 122. The distances D1 and D2 may be such that the motor 110 is disposed at a substantial distance from the two rotors.

In use, when the motor is powered up, the rotors 120, 122 may turn in opposite directions from one another. For example, the front (or topmost) rotor 120 (and the drive shaft 114) may turn in a clockwise (CW) direction, whilst the rear (or bottom) rotor 122 (and the motor housing 112) may turn in a counter-clockwise (CCW) direction. Such contra-rotation of rotors has several advantages, which are well known and which have been mentioned elsewhere. The two rotors 120 and 122 may be referred to as a “rotor system” (or “propeller system”, or “thrust system”).

The motor 110 may be mounted to a fixed support structure 130, such as an airframe of an aircraft, in a manner that allows the motor itself to rotate (spin about its axis) relative to the fixed structure. (In the figure, the fixed structure is shown spaced apart from the motor, for illustrative clarity.) To this end, bearings 132 and 134 may be provided between the fixed structure and the motor housing 112, supporting the motor housing. One such bearing 132 may be disposed towards a front end (top) of the motor. Another such bearing 134 may be disposed towards the back end (bottom) of the motor. With the two bearings, located as shown (and described), this will ensure that the motor remains fixed in position with respect to the fixed structure, while being able to rotate freely.

In order to power the motor, two or three slip rings (or power rails) 136 may be disposed on an exterior surface of the motor, and corresponding two or three brush assemblies 138 may be disposed in a suitable manner on the support structure 130. (A single brush assembly may comprise a single brush, but better if it has two or more brushes contacting its corresponding slip ring.) Two slip rings and brushes are shown, such as for 2-phase AC or for DC operation of the motor. Three slip rings and brushes may be required for 3-phase operation. The motor housing itself may be ground (earth).

The slip rings should be electrically insulated from the motor housing, and may be mounted on spokes or the like so that they are located a bit radially outward from the outer surface of the motor housing. This would enable one slip ring assembly to be used with motors of different sizes (diameters), without changing the size of the brush assembly.

Internal electrics of the motor are omitted, for illustrative clarity. A braking mechanism (if any) is omitted, for illustrative clarity. External controls for monitoring and controlling the operation of the motor are also omitted. The propellers (or rotors) are exemplary of any driven devices, such as turbine blades and the like. Control rods (if any) for varying the pitch of the blades are not shown.

The combined motor and rotor system disclosed herein may be useful for providing lift to flying machines such as helicopters or drones. Other applications which utilize the displacement of fluid for propulsion or to propel fluids where the benefits of torque balance provides advantages such as boats, submarines, torpedoes, wind turbines, hydroelectric generators, submerged pumps, ceiling cooling fans may also benefit from the techniques disclosed herein.

### APPENDICES

APPENDIX 1, incorporated by reference herein, is an illustrated presentation describing (i) prior art, (ii) the innovation disclosed herein, (iii) embodiment example, (iv) effects of breaking (sic) the rotors (v) car embodiment, (vi) additional notes.

Note: “breaking” should read “braking”.

Some of the text of APPENDIX 1 may be presented/paraphrased here:

A conventional electric motor has an output shaft (rotor 1) which extends from the front end of the motor and which spins in one (a given) direction. Left unrestrained, the motor housing would tend to rotate in the opposite direction from the rotor.

Step 1a. provide conductive tracks (rails) on the exterior of the motor housing, and external brushes to get power into the (electric) motor. This may be akin to a commutator/brush arrangement.

Step 1b. extend the front of motor housing to provide a second output shaft (rotor 2) coaxial with and surrounding rotor 1. With the motor housing (and rotor 2) left unrestrained, the motor housing (and rotor 2) would tend to rotate in the opposite direction from the rotor. Alternatively, the rear of the housing could be extended to provide the second, contra-rotating, collinear (coaxial) rotor. Rather than “extending”, a separate piece (collar) may be mounted to the housing.

Step 2. provide external bearings on the motor housing, so that it may be mounted to (or in) a “fixed” structure, such as an airframe, or a wind turbine pylon.

With contra-rotating coaxial rotors, braking (“breaking”) of one rotor may cause a net torque for controlling the yaw of the aircraft.

APPENDIX 2, incorporated by reference herein, shows the dual rotor system of the present invention in a vertical orientation with the contra-rotating rotors (propellers) disposed above a user who is standing on a platform representative of (for example) a helicopter. There are 3 figures.

View A shows the rotors disposed above the user, and the motor is disposed much lower, resulting in a low center of gravity.

View B shows the propeller force (top large arrow), the weight force (bottom large arrow), and the center of gravity. The low center of gravity results in greater stability, versus “top heavy” (unstable)

View C-1 shows that the incorporation of a universal joint (or pivot) in the drive allows for the rotors to easily be tilted, in all directions, which is necessary for directing the flight path of the helicopter. Here, the motor swings (tilts) in a direction opposite from that of the rotor.

View C-2 shows that the incorporation of a universal joint in the drive allows for the rotors to easily be tilted, in all directions, which is necessary for directing the flight path of the helicopter. Here, the motor is not tilted.

View D

The torque (τ) applied to each rotor axis is the product of the moment of inertia (I) and the angular acceleration (α).

τ=Iα

The moment of inertia is a quantity expressing a body's tendency to resist angular acceleration. It is the sum of the products of the mass of each particle in the body with the square of its distance from the axis of rotation. Since both axes rotate about the same axis it is expected that the internal and external rotors would have differing moments of inertia based on the mechanics and selection of motor magnets and windings configurations.

Since the torque generated by the motor is split equally between the outer (o) and inner (i) rotors the toque equation may be expressed as follows:

τₒ=Iₒαₒ τᵢ=τIᵢαᵢ

Iₒαₒ=Iᵢαᵢ

If the internal rotor and external rotor moment of inertia differ then during motor start up, as the rotors spin-up under motor force, they would experience different accelerations. So when acceleration reaches zero and the motor is not changing power rates, each rotor would have a different rotational speed.

Different rotational speed would lead to difference in forces (downward, drag, etc) generated by the internal and external propellers. This force differential would lead to net forces acting on the system and would require other mechanisms for balancing them out.

However, equalizing the moments of inertia of both rotors would lead to both rotors experiencing and reaching the same rotational speeds. This would eliminate the unequal forces generated by the propellers due to the differing rotational speeds.

Mass may be added to one or both of the rotors (or propellers) so that their moments of inertial are equal.

View E

Selectively applying braking forces selectively to internal and external rotors to generate net rotation whereby τₒ≠τᵢ, and causing the system to rotate about itself.

114=internal rotor

116=external rotor

View F

Further improvements in system torque equalization may be achieved by applying bearings of equal size and quantity to each of the inner and outer rotors, thereby distributing and balancing the bearing drag forces to both rotors so Dᵢ=Dₒ.

114=inner rotor

116=outer rotor

### Distinguishing Over JP 2012011990

This publication (“JP 990”) shows a thrust device that can easily produce machines capable of vertical takeoff and landing.

As best understood, FIG. 2 shows a contra-rotating propeller, as follows:

1 motor having a field case (housing)

2 output (drive) shaft coming out of the front (top) of the motor

3 first propeller (or rotor) disposed on the front of the motor, driven by the drive shaft 2

3a hub for the first propeller 3

The drive shaft rotates in one direction while the motor case rotates in an opposite direction.

4 second propeller (or rotor) disposed on the back (bottom) of the motor

4a hub for the second propeller 4

5a shaft mounted to the motor, at the back of the motor

6 bearings supporting the shaft

7 electrodes attached to the shaft

8 power supply brushes attached to the bearing case

In a vertical orientation, the front of the motor will be the top of the motor, and the back (or rear) of the motor will be the bottom of the motor.

JP 990 has a motor, and two contra-rotating propellers. A first propeller is attached to the output shaft of the motor, and rotates in a first direction, at the front of the motor. A second propeller is attached to the motor housing, and rotates in a second direction, at the rear of the motor. Applicant similarly has a motor, and two contra-rotating propellers. A first propeller is attached to the output shaft of the motor, and rotates in a first direction, at the front of the motor. A second propeller is attached to the motor housing, and rotates in a second direction, also at the front of the motor.

JP 990 locates the motor between the two contra-rotating propellers. One propeller is disposed at the front of the motor, the other propeller is disposed at the rear of the motor. The motor is therefore in the airflow between the two propellers. Applicant locates both of the two contra-rotating propellers at one end (the front) of the motor. In this manner, the motor does not restrict (or otherwise interfere) with the airflow.

JP 990's motor is disposed within the contra-rotating propeller system. In a vertical orientation (such as for a helicopter) this results in an undesirably high center of gravity Applicant's motor is disposed away (distant) from the contra-rotating propeller system, resulting in a desirably low center of gravity. Applicant's motor is “position independent”, meaning that it can be located away from the rotors.

Locating the motor between the rotors is also an obstacle, for example, to having pitch control rods (such as for control rods, cyclic and collective) extending to the front rotor. Locating the motor remote from the propeller system enables control rods and the like to be disposed in the space between the two rotors.

Locating the motor between the rotors may also limit the size (or impose some gnarly design restraints) on the second rotor 4. Applicant's design does not suffer from these drawbacks.)

Locating the motor between the rotors also means that in order to tilt the propellers (rotor system), it is necessary to tilt the motor with the rotor.

JP 990 supports the motor by a shaft 4 extending from the back of the motor. The motor is not well supported. This cantilevered support is not robust. Applicant's motor is well supported by bearings 134 disposed directly on the motor casing.

JP 990 powers the motor via slip rings and brushes (electrodes 7) located on a shaft 5 mounted to the motor, at the back of the motor. Applicant's slip rings 136 are disposed about the motor housing, resulting in a larger diameter. A larger diameter slip ring, disposed on the outside of the motor housing may be better than a smaller one (as in JP 990) because (i) traditional motor configurations have the power connections on the case (housing) and not on the the internal rotor and (ii) larger slip rings allow for higher power transfers since the perimeter (circumference, hence surface area) is larger allowing for more cooling of the surface of the slip ring(s) between brush passes. Alternatively, Applicant could use the slip ring/brush arrangement of JP 990.

While the invention(s) has/have been described with respect to a limited number of embodiments, these should not be construed as limitations on the scope of the invention(s), but rather as examples of some of the embodiments. Those skilled in the art may envision other possible variations, modifications, and implementations that are also within the scope of the invention(s), based on the disclosure(s) set forth herein.

What is claimed is:

1. Dual rotor system comprising:
a motor comprising a housing and a first output shaft (or rotor) extending from a front (top) end of the motor; and
an extension of the housing extending from the front end of the motor, said extension being coaxial with the output shaft and functioning as a second output shaft (or rotor).

2. The dual rotor system of claim 1, further comprising:
a first propeller (rotor) driven by the first output shaft, in a first direction; and
a second propeller (rotor) driven by the second output shaft, in a second direction opposite to the first direction;
wherein, when the motor is powered, the rotors rotate in opposite directions.

3. The dual rotor system of claim 1, wherein:
the two rotors are disposed on the same end of the motor.

4. The dual rotor system of claim 1, wherein the motor is an electric motor, and further comprising:
slip rings (conductive tracks) disposed on an exterior of the motor housing;
brushes cooperating with (contacting) the slip rings, and receiving electrical power from an external source to power the electric motor.

5. The dual rotor system of claim 1, further comprising:
at least one bearing disposed about the motor housing to support the motor with respect to a “fixed” external structure (such as airframe or pylon).

6. The dual rotor system of claim 1, further comprising:
a universal joint disposed between the motor and the rotors to allow the rotors to tilt.

7. The dual rotor system of claim 6, wherein:
the first and second output shafts are relatively long, and the universal joint is disposed relatively close to the rotors.

8. A flying machine incorporating the dual rotor system of claim 1.

9. The dual rotor system of claim 1, further comprising:
mass added to one or both of the rotors (or propellers) so their moments of inertial are equal.

10. The dual rotor system of claim 1, further comprising:
means for applying braking forces selectively to the rotors.

11. The dual rotor system of claim 1, wherein:
bearings of equal size are mounted to support both the inner and outer rotors to a “fixed” external structure (such as airframe or pylon).

12. The dual rotor system of claim 1, wherein:
bearings of equal quantity are mounted to support both the inner and outer rotors to a “fixed” external structure (such as airframe or pylon).

13. A method of driving contra-rotating propellers, comprising:
providing an electric motor comprising a housing and a first output shaft extending from a front (top) end of the motor; and an extension of the housing extending from the front end of the motor, said extension being coaxial with the output shaft and functioning as a second output shaft;
disposing propellers on the first and second output shafts; and
powering the motor.

14. The method of claim 13, further comprising:
adding mass to one or both of the rotors (or propellers) so their moments of inertial are equal.

15. The method of claim 13, further comprising:
applying braking forces selectively to the rotors.

16. The method of claim 13, further comprising:
mounting bearings of equal size to support both of the rotors to a “fixed” external structure (such as airframe or pylon).

17. The method of claim 13, further comprising:
mounting bearings of equal quantity to support both of the rotors to a “fixed” external structure (such as airframe or pylon).
